(19) United States
(12) Patent Application Publication
(10) Pub. No.: US 2016/0349596 A1
(43) Pub. Date: Dec. 1, 2016

(54) ACTUATOR FOR CAMERA

(71) Applicant: JAPAN AVIATION ELECTRONICS INDUSTRY, LIMITED, Tokyo (JP)

(72) Inventors: Takahiro YAMAJI, Tokyo (JP); Akihiro MATSUNAGA, Tokyo (JP); Hiroshi AKIMOTO, Tokyo (JP); Kazuaki IBARAKI, Tokyo (JP); Fuminobu ONO, Tokyo (JP); Jun SHINDOU, Tokyo (JP)

(73) Assignee: JAPAN AVIATION ELECTRONICS INDUSTRY, LIMITED, Tokyo (JP)

(21) Appl. No.: 15/093,862

(22) Filed: Apr. 8, 2016

(30) Foreign Application Priority Data
May 25, 2015 (JP) 2015-105176

(51) Int. Cl. G03B 13/36; G02B 27/64; G02B 7/09

(52) U.S. Cl. CPC G03B 13/36; G02B 7/09; G02B 27/646

(57) ABSTRACT

An actuator for camera which drives a lens unit of a camera includes an outer frame, an inner frame which houses and holds the lens unit and is positioned inside the outer frame, a plurality of first supporting members which are provided between the outer frame and the inner frame and support the inner frame with respect to the outer frame so that the inner frame is displaceable in an optical axis direction of the lens unit, a first driving coil which is attached on an outer circumferential surface of the inner frame and drives the inner frame in the optical axis direction, and permanent magnets which are attached to the outer frame in a manner to be opposed to the first driving coil. The first supporting members are made of elastomer and have a shape of which a center line is a straight line which connects mutually opposed portions of the outer frame and the inner frame. An actuator for camera which is superior in productivity, reliability, and durability can be obtained.

### TECHNICAL FIELD

The present invention relates to an actuator for camera which drives a lens unit of a camera.

### BACKGROUND ART

FIG. 1 illustrates the configuration of an actuator for auto focusing which is described in Japanese Patent Application Laid Open No. 2006-251728 (published on Sep. 21, 2006) as an example of this type of actuator of prior art.

The actuator for auto focusing in this example includes a holder 12 which has a cylindrical portion 12a to which a lens assembly 11 is attached, a coil 13 which is disposed around the cylindrical portion 12a and fixed to the holder 12, a yoke 15 having a permanent magnet 14 which is opposed to the coil 13, an upper leaf spring 16U and a lower leaf spring 16L which are respectively provided on both sides in an optical axis direction of the cylindrical portion 12a of the holder 12 and support the holder 12 so that the holder 12 is displaceable in the optical axis direction while positioning the holder 12 in the radial direction, a stopper 17 which holds the upper leaf spring 16U between the stopper 17 and the holder 12, a cover 18 and a base 19 which constitute a pair of support frames which are respectively provided to the outsides, in the optical axis direction, of the stopper 17 and the lower leaf spring 16L, respectively hold the upper leaf spring 16U and the lower leaf spring 16L between the cover 18 and one end surface, in the optical axis direction, of the yoke 15 and between the base 19 and the other end surface of the yoke 15, and respectively have openings at parts corresponding to the lens assembly 11 which is attached to the holder 12, and a sheet-shaped electrode 20 which is provided between the lower leaf spring 16L and the base 19 so as to supply power to the coil 13.

This actuator for auto focusing supplies electricity to the coil 13 so as to be able to adjust a position of the lens assembly 11, which is attached to the holder 12, in the optical axis direction due to an interaction between a magnetic field of the permanent magnet 14 and current flowing in the coil 13.

FIG. 2 shows the shape of the leaf spring 16 (the upper leaf spring 16U, the lower leaf spring 16L) which are used in this actuator for auto focusing. The leaf spring 16 is composed of a metal thin plate and is formed in a gimbal spring shape to include an inner annular portion 16a, an outer annular portion 16b which is provided with a predetermined interval with respect to the inner annular portion 16a, and a plurality of coupling portions 16c which couple the inner annular portion 16a and the outer annular portion 16b.

The inner annular portion 16a of the upper leaf spring 16U is bonded to the holder 12 in a manner to be sandwiched between an upper surface of the holder 12 and a lower surface of the stopper 17 and the outer annular portion 16b is bonded to the cover 18 and the yoke 15 in a manner to be sandwiched between a lower surface of the cover 18 and an upper surface of a coupling portion 15a of the yoke 15. Further, the inner annular portion 16a of the lower leaf spring 16L is bonded to a lower surface of the holder 12 and the outer annular portion 16b is bonded to the base 19 and the yoke 15 in a manner to be sandwiched between an end surface of an outer cylindrical portion 15b of the yoke 15 and an upper surface of the base 19.

The leaf spring 16 (the upper leaf spring 16U, the lower leaf spring 16L) which are thus attached support the holder 12 so that the holder 12 is displaceable in the optical axis direction due to elastic deformation of the coupling portions 16c thereof.

As mentioned above, a leaf spring is used to support a holder, which supports a lens assembly, so that the holder is displaceable in the optical axis direction, in an actuator for camera for auto focusing of prior art.

On the other hand, this type of actuator is used for camera-equipped small-size electronic apparatuses such as a mobile telephone and a smart phone, a digital camera, and the like and an actuator for camera is required to also be reduced in size along with the size reduction of these apparatuses. Therefore, a leaf spring is also reduced in size and the plate thickness is reduced as well, so that a portion (the coupling portion 16c) of which predetermined elastic deformation is required becomes very thin and slim in the leaf spring 16 which has the shape as illustrated in FIG. 2. Accordingly, when an unpredictable outer force is applied in a manufacturing process, the coupling portion 16c easily deforms (plastic deformation). Thus, there is a problem of lowering of yield.

Further, if an impact is applied by dropping or the like in use, plastic deformation is easily generated in the coupling portion 16c which is thin and slim. From this point, an actuator for camera which uses such leaf spring has had a problem on reliability and durability.

### SUMMARY OF THE INVENTION

An object of the present invention is to provide an actuator for camera which is superior in productivity, reliability, and durability.

According to the present invention, an actuator for camera which drives a lens unit of a camera includes an outer frame, an inner frame which houses and holds the lens unit and is positioned inside the outer frame, a plurality of first supporting members which are provided between the outer frame and the inner frame and support the inner frame with respect to the outer frame so that the inner frame is displaceable in an optical axis direction of the lens unit, a first driving coil which is attached on an outer circumferential surface of the inner frame and drives the inner frame in the optical axis direction, and permanent magnets which are attached to the outer frame in a manner to be opposed to the first driving coil, in which the first supporting members are made of elastomer and have a shape of which a center line is a straight line which connects mutually opposed portions of the outer frame and the inner frame.

According to the actuator for camera of the present invention, the first supporting members which support the inner frame which houses and holds the lens unit so that the inner frame is displaceable in the optical axis direction are made of elastomer and have a simple shape of which a center line is a straight line. Therefore, such problems that manufacturing is difficult and plastic deformation is easily generated as a case where a leaf spring made of metal is used in prior art do not arise and an actuator for camera which is superior in productivity on these points and further, is superior in reliability and durability can be obtained.

### BRIEF DESCRIPTION OF THE DRAWINGS

FIG. 1 is a sectional view illustrating an example of an actuator for camera of prior art.

FIG. 2 is a plan view illustrating a leaf spring of FIG. 1.

FIG. 3 is a perspective view illustrating an actuator for camera, according to an embodiment of the present invention, to which a lens unit is attached.

FIG. 4 is a perspective view illustrating the actuator for camera shown in FIG. 3 in a manner to separate the actuator for camera into a cover and an actuator body.

FIG. 5A is a plan view illustrating the actuator body shown in FIG. 4.

FIG. 5B is a front elevational view illustrating the actuator body shown in FIG. 4.

FIG. 5C is a section-perspective view illustrating the actuator body shown in FIG. 4.

FIG. 6 is a perspective view illustrating the actuator body, which is shown in FIG. 4, in a partially-exploding manner.

FIG. 7 is an exploded perspective view viewed from the obliquely-upper direction and illustrating the configurations of respective parts other than a substrate of the actuator body shown in FIG. 4.

FIG. 8 is an exploded perspective view viewed from the obliquely-lower direction and illustrating the configurations of respective parts other than the substrate of the actuator body shown in FIG. 4.

FIG. 9A is a plan view illustrating a molding completion state in which an outer frame and an inner frame are integrally formed.

FIG. 9B is a front elevational view of the molding completion state shown in FIG. 9A.

FIG. 9C is a perspective view of the molding completion state shown in FIG. 9A.

FIG. 10 is a perspective view illustrating only a molded part of the actuator body shown in FIG. 4.

FIG. 11 illustrates an actuator for camera according to another embodiment of the present invention.

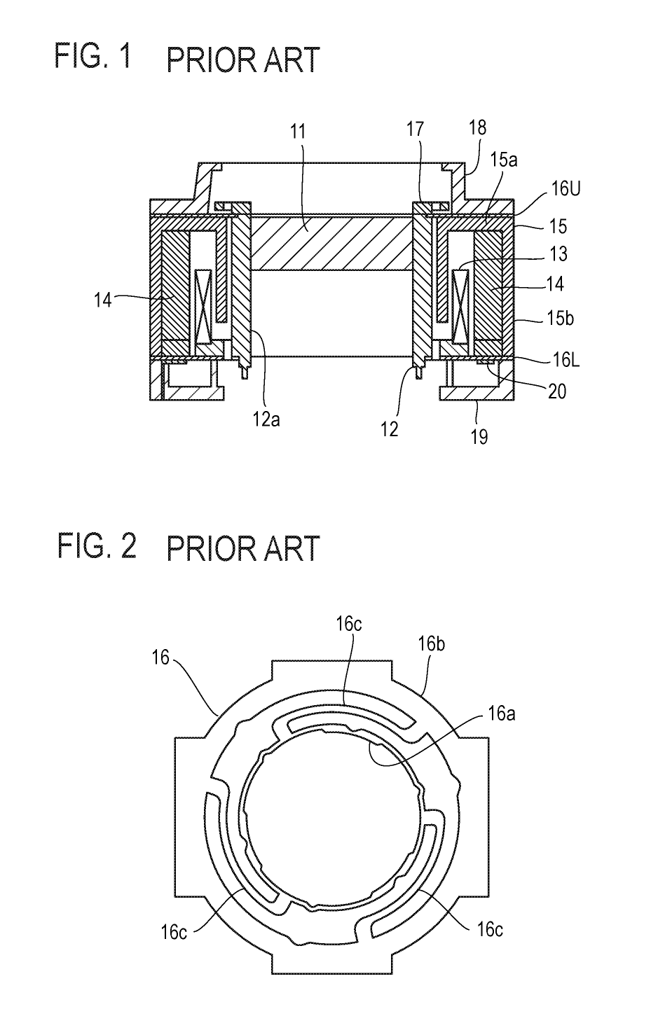

### DETAILED DESCRIPTION OF THE EMBODIMENTS

Embodiments of the present invention will be described below.

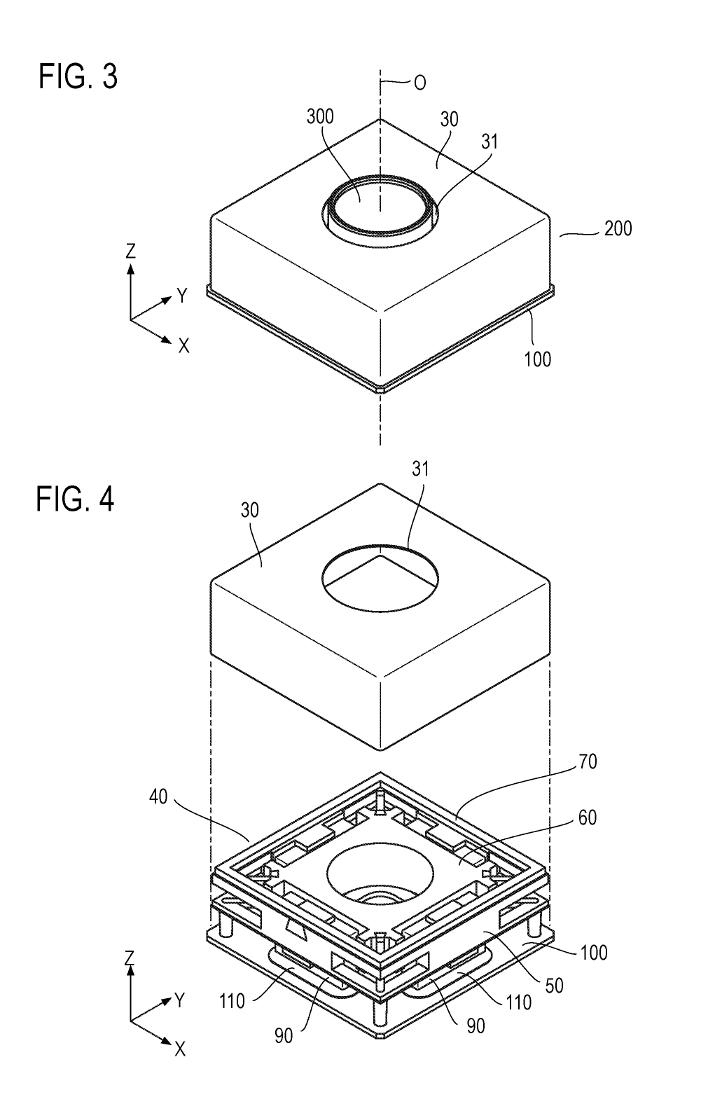

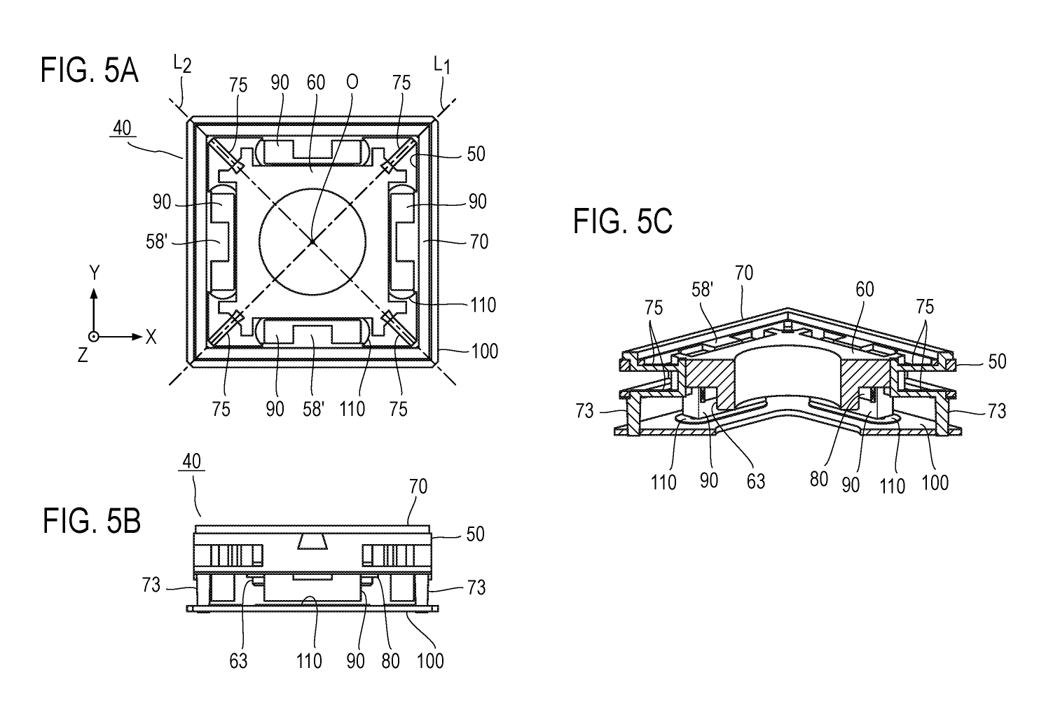

FIG. 3 illustrates an actuator for camera according to an embodiment of the present invention in a state in which a lens unit is attached, and FIG. 4 illustrates a cover of the actuator for camera and an actuator body separately by detaching the cover. Further, FIGS. 5A to 5C illustrate details of the actuator body.

An actuator for camera 200 has both functions of auto focusing and camera shake correction in this example. The actuator for camera 200 is capable of displacing a lens unit 300 in an optical axis direction and further, is capable of displacing the lens unit 300 in first and second directions which are orthogonal to the optical axis direction and are orthogonal to each other. In FIG. 3, O denotes an optical axis of the lens unit 300. Here, the optical axis direction of the lens unit 300 is set to the Z direction and the first and second directions which are orthogonal to the optical axis direction and are orthogonal to each other are set to the X direction and the Y direction respectively in the following description.

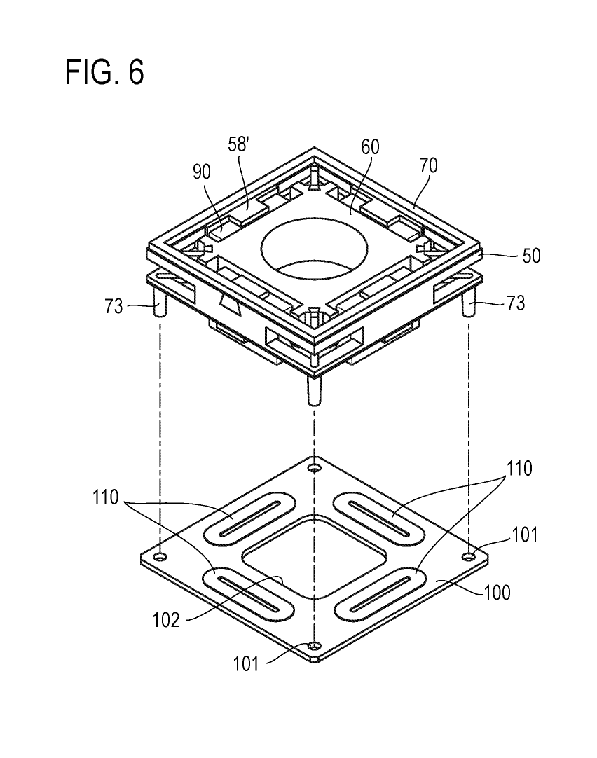

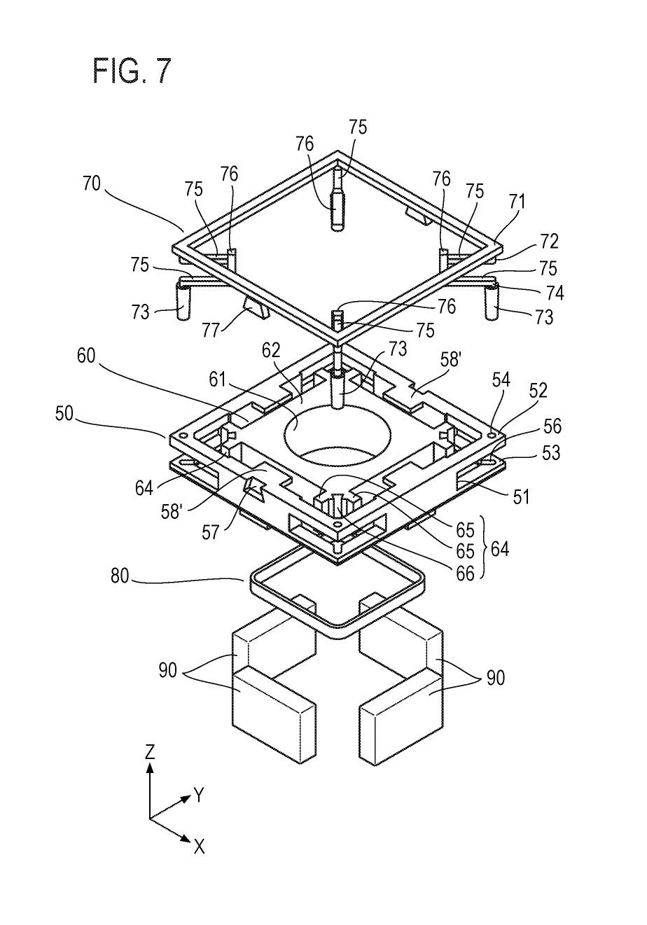

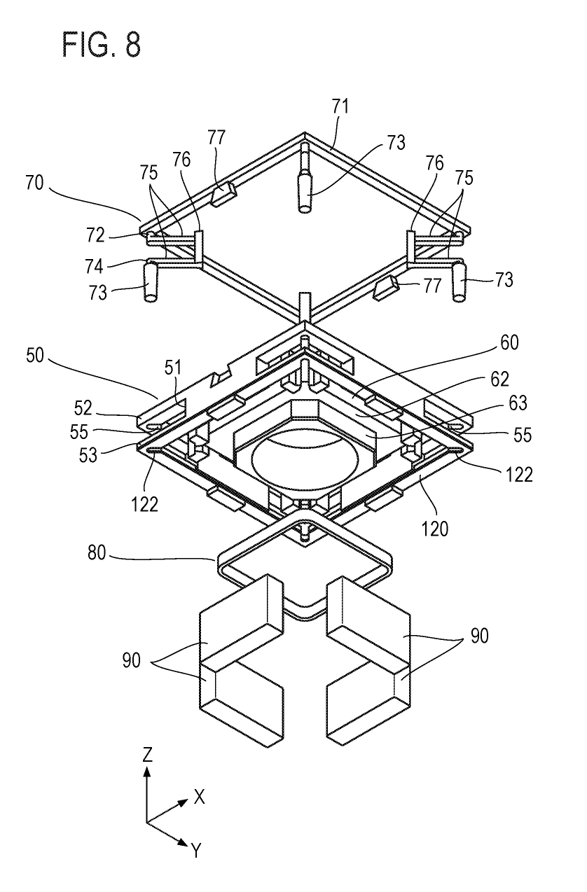

The actuator for camera 200 is composed of a cover 30 and an actuator body 40 as illustrated in FIG. 4. The actuator body 40 is composed of an outer frame 50, an inner frame 60, a supporting member 70, a first driving coil 80, a permanent magnet 90, and the substrate 100, and a second driving coil 110 is formed on the substrate 100 as illustrated in FIGS. 5A to 5C. FIG. 6 illustrates the substrate 100 and parts other than the substrate 100 separately by partly disassembling the actuator body 40. FIG. 7 and FIG. 8 illustrate the configurations of respective parts other than the substrate 100 of the actuator body 40.

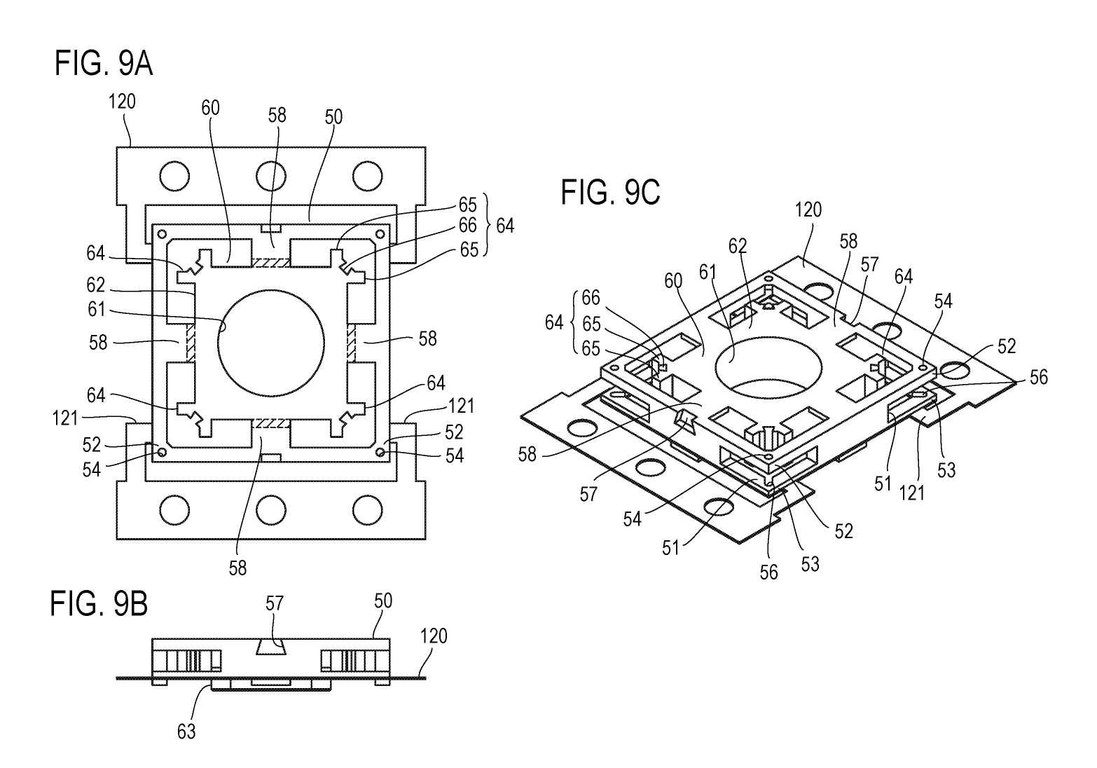

The outer frame 50 and the inner frame 60 are made of resin. These outer frame 50 and inner frame 60 are formed such that the outer frame 50 and the inner frame 60 are integrally molded and then separated from each other in this example. FIGS. 9A to 9C illustrate a molding completion state of the outer frame 50 and the inner frame 60. In FIGS. 9A to 9C, 120 denotes a carrier for conveyance in a manufacturing process. The carrier 120 is insert-molded in the outer frame 50. Bridge portions 121 of the carrier 120 composed of a metal plate are cut to be removed, but the carrier 120 remains at a bottom surface portion of the outer frame 50 as illustrated in FIG. 8.

The supporting member 70 is made of thermoplastic elastomer. The supporting member 70 is formed by secondary molding on the outer frame 50 and the inner frame 60 which are in the state illustrated in FIGS. 9A to 9C and is integrated with the outer frame 50 and the inner frame 60 in this example. Here, in order to clearly show a molding shape of the supporting member 70, the supporting member 70 is illustrated separately from the outer frame 50 and the inner frame 60 in FIG. 7 and FIG. 8.

The configurations of the outer frame 50, the inner frame 60, and the supporting member 70 are described below.

The outer frame 50 has a square frame shape. In an intermediate portion in the thickness direction on each corner portion of the outer frame 50, an opening 51 is formed along adjacent two sides and the corner portion is separated into an upper corner portion 52 and a lower corner portion 53 by the opening 51. In each upper corner portion 52, a hole 54 is formed to penetrate the upper corner portion 52 in the thickness direction. On a lower surface of the upper corner portion 52, a groove 55 is formed from the hole 54 to an inner circumferential surface of the outer frame 50 as illustrated in FIG. 8. In each lower corner portion 53, a notch 56 is formed in a manner to be cut out from the inner circumferential surface of the outer frame 50 and to be opposed to the hole 54 and the groove 55 of the upper corner portion 52, and a notch 122 similar to the notch 56 is also formed on the carrier 120.

On an outer circumferential surface on each central portion of two opposed sides of the outer frame 50, a concave portion 57 is formed. The concave portion 57 is formed to face the upper surface of the outer frame 50 and has a trapezoid shape of which the upper surface side is narrower. Here, after the outer frame 50 and the inner frame 60 are integrally molded while being coupled by coupling portions 58 as illustrated in FIG. 9A, the outer frame 50 and the inner frame 60 are finally separated from each other by cutting out hatched parts in FIG. 9A. A protrusion portion 58′ which is protruded from the central portion of each side of the outer frame 50 to the inside is a residual part of the coupling portion 58.

The inner frame 60 which is positioned inside the outer frame 50 includes a base 62 in which a large housing hole 61 is formed at the center and of which an outer shape is square, a cylindrical portion 63 which is formed on a lower surface side of the base 62 in a protruded manner to surround the housing hole 61, and a connecting portion 64 which is formed on each corner portion of the square of the base 62. An outer circumferential surface of the cylindrical portion 63 makes a square shape of which corner portions are chamfered as illustrated in FIG. 8.

The connecting portion 64 is composed of a pair of protrusion portions 65 which are formed to be protruded respectively from adjacent two sides of the base 62 and to mutually make 90° on each of the corner portions of the base 62 and a groove 66 which is formed between a pair of protrusion portions 65 in a manner to have a narrower entrance. The upper surfaces of the protrusion portions 65 are positioned on an identical plane to the upper surface of the base 62 and the lower surfaces thereof are slightly protruded more than the lower surface of the base 62.

The supporting member 70 includes a frame portion 71 which is square, a boss 72 which is protruded from a lower surface of each corner portion of the frame portion 71, a columnar portion 73 which is positioned below each boss 72, extended portions 75 which are extended respectively from a lower end of the boss 72 and a boss 74 which is provided on an upper end of the columnar portion 73 toward a central axis of the square made by the frame portion 71, a coupling portion 76 which couples inner ends (tips) of two extended portions 75 which are positioned on each corner portion, and a protrusion portion 77 which is protruded from the lower surface of a central portion of each of two opposed sides of the frame portion 71.

As described above, the supporting member 70 is formed on the outer frame 50 and the inner frame 60 by secondary molding and the frame portion 71 is positioned on the outer frame 50. The coupling portion 76 is positioned on the groove 66 of the inner frame 60 and the protrusion portion 77 and the bosses 72 and 74 are positioned on the concave portion 57, the hole 54, and the notch 56 of the outer frame 50 respectively. The outer end sides of two extended portions 75 which are positioned on each corner portion are respectively positioned on the groove 55 and the notch 56 of the outer frame 50 and the columnar portion 73 is positioned to be protruded to the lower surface side of the outer frame 50.

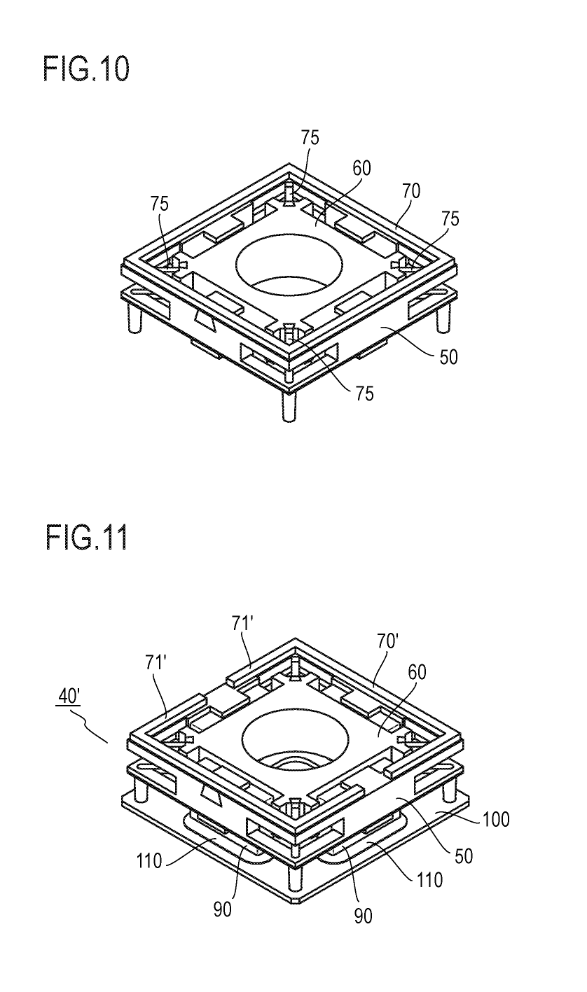

FIG. 10 illustrates a state in which the supporting member 70 is formed on the outer frame 50 and the inner frame 60 which are illustrated in FIGS. 9A to 9C by secondary molding, then the coupling portions 58 are cut out, and the carrier 120 which is positioned outside the outer frame 50 is cut and removed. The supporting member 70 has a shape which is fitted in the outer frame 50 and the inner frame 60 as described above, so that the supporting member 70 is solidly fixed on the outer frame 50 and the inner frame 60 and the inner frame 60 is supported by the outer frame 50 via eight extended portions 75 in total.

With respect to a molded part (the outer frame 50, the inner frame 60, the supporting member 70) illustrated in FIG. 10, the first driving coil 80 and the permanent magnets 90 are attached. The first driving coil 80 is attached to the outer circumferential surface of the cylindrical portion 63 of the inner frame 60 and four permanent magnets 90 which have a block shape are attached to the inner circumferential surface of the outer frame 50 in a manner to be opposed to the first driving coil 80. The permanent magnets 90 are respectively attached to the center of respective sides of the outer frame 50 in such state that upper surfaces thereof are abutted on the protrusion portions 58′ of the outer frame 50. Here, in four permanent magnets 90, surfaces which face the first driving coil 80 are set as the north pole and the opposite surfaces are set as the south pole, for example.

The molded part to which the first driving coil 80 and the permanent magnets 90 are attached as described above is mounted on the substrate 100. Accordingly, the actuator body 40 is completed. The substrate 100 is square as illustrated in FIG. 6 and lower ends of the columnar portions 73 of the supporting member 70 are respectively inserted into holes 101, which are provided to respective corner portions, and are bonded to be fixed, for example. The outer frame 50 to which the permanent magnets 90 are attached and the inner frame 60 to which the first driving coil 80 is attached are positioned above the substrate 100 to be separated from the substrate 100 with a predetermined distance.

In a central portion of the substrate 100, a window 102 which is square of which corners are rounded, in this example, is formed, and the second driving coils 110 are patterned on the substrate 100 along respective sides of the window 102. The second driving coils 110 have an elongated loop shape as illustrated in FIG. 6 and are formed to be respectively opposed to the lower surfaces of four permanent magnets 90 which are attached to the outer frame 50.

The cover 30 is covered on the actuator body 40 and accordingly, the actuator for camera 200 is completed. The lens unit 300 is housed and held in the housing hole 61 of the inner frame 60 to face the outside from an opening 31 of the cover 30.

According to the actuator for camera 200 which is configured as described above, eight extended portions 75, in total, of the supporting member 70 are positioned between the outer frame 50 and the inner frame 60 to connect the outer frame 50 and the inner frame 60 and the inner frame 60 which houses and holds the lens unit 300 is supported with respect to the outer frame 50 by the extended portions 75 to be displaceable in the Z direction.

The extended portion 75 has a square bar shape in this example and a straight line connecting mutually opposed portions of the outer frame 50 and the inner frame 60 is a center line of the extended portion 75. The center lines of the extended portions 75 are extended lines of diagonal lines L₁ and L₂ of the square which is the shape of the inner frame 60 in this example as illustrated in FIG. 5A. Four extended portions 75 are provided on each of the front side and the rear side, in the Z direction, of the inner frame 60 and four corner portions of the square of the inner frame 60 are supported by these extended portions 75. Here, though such arrangement configuration of the extended portions 75 is employed, the extended portions 75 which are made of elastomer stretch. Therefore, the inner frame 60 is displaceable in the Z direction. The optical axis O of the lens unit 300 is positioned on an intersection of the diagonal lines L₁ and L₂.

When the first driving coil 80 is energized, the inner frame 60 is driven in the Z direction by an interaction between the magnetic field of the permanent magnets 90 and current flowing in the first driving coil 80.

On the other hand, the outer frame 50 is supported by four columnar portions 73, of which one ends (lower ends) are fixed on the substrate 100, of the supporting member 70 and the outer frame 50 is displaceable in the X direction and the Y direction with respect to the substrate 100 by these columnar portions 73.

When required electricity is supplied to four second driving coils 110 which are formed on the substrate 100 to be opposed to the permanent magnets 90 in the Z direction, the outer frame 50 is driven in the X direction and the Y direction by an interaction between the permanent magnets 90 and current flowing in the second driving coils 110.

The embodiment of the present invention has been described thus far. In this example, the supporting member 70 which is configured such that the first supporting members which support the inner frame 60 so that the inner frame 60 is displaceable in the Z direction and the second supporting members which support the outer frame 50 so that the outer frame 50 is displaceable in the X direction and the Y direction are integrally formed is provided, that is, the extended portions 75 of the supporting member 70 function as the first supporting members and the columnar portions 73 function as the second supporting members. However, the first supporting members and the second supporting members can be separately formed.

The frame shape of the outer frame 50 and the outer shape of the inner frame 60 are not limited to a square, but shapes other than the square may be employed.

The substrate 100 is a rigid printed wiring board in this example. Instead of this, a flexible printed wiring board may be used. In a case where a flexible printed wiring board is used, the flexible printed wiring board is disposed and fixed on a base plate such as a metal plate.

The first supporting members (the extended portions 75 in the above-described example) which support the inner frame 60 so that the inner frame 60 is displaceable in the Z direction are provided on four parts around the inner frame 60 in two levels in the Z direction in such state that the center lines of the first supporting members are extended lines of the diagonal lines L₁ and L₂ of the inner frame 60 in the above-described example, but the configuration is not limited to this. The configuration of the first supporting members may depend on an outer shape of the inner frame 60. For example, in a case where the outer shape of the inner frame 60 is circular, the configuration in which three parts around the inner frame 60 are supported by the first supporting members can be employed. Further, even though the outer shape of the inner frame 60 is square, the first supporting members do not always have to be positioned on extensions of the diagonal lines.

The first supporting members and the second supporting members respectively support the inner frame 60 so that the inner frame 60 is displaceable in the Z direction and support the outer frame 50 so that the outer frame 50 is displaceable in the X and Y directions. When the first supporting members and the second supporting members are made of conductive elastomer, the first supporting members and the second supporting members can be used also as leads (lead wires) of the first driving coil 80.

FIG. 11 illustrates a configuration example of an actuator body of this case. Different from the actuator body 40 described above, an actuator body 40′ includes a supporting member 70′ which is made of conductive elastomer and of which a frame portion 71′ is divided into two. If the supporting member 70′ has such configuration, the supporting member 70′ can be used also as leads of the first driving coil 80 and both ends of the first driving coil 80 are connected to the supporting member 70′ which is divided into two respectively.

The foregoing description of the embodiments of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An actuator for camera which drives a lens unit of a camera, the actuator for camera comprising:
an outer frame;
an inner frame which houses and holds the lens unit and is positioned inside the outer frame;
a plurality of first supporting members which are provided between the outer frame and the inner frame and support the inner frame with respect to the outer frame so that the inner frame is displaceable in an optical axis direction of the lens unit;
a first driving coil which is attached on an outer circumferential surface of the inner frame and drives the inner frame in the optical axis direction; and
permanent magnets which are attached to the outer frame in a manner to be opposed to the first driving coil; wherein
the first supporting members are made of elastomer and have a shape of which a center line is a straight line which connects mutually opposed portions of the outer frame and the inner frame.

2. The actuator for camera according to claim 1, wherein the first supporting members have a bar shape and a plurality of first supporting members are provided on each of a front side and a rear side of the inner frame in the optical axis direction.

3. The actuator for camera according to claim 1, wherein
the inner frame has a square shape, and
the center line is an extended line of a diagonal line of the square shape and each corner portion of the square shape is supported by the first supporting members.

4. The actuator for camera according to claim 2, wherein
the inner frame has a square shape, and
the center line is an extended line of a diagonal line of the square shape and each corner portion of the square shape is supported by the first supporting members.

5. The actuator for camera according to claim 1, wherein
the outer frame is supported by a plurality of second supporting members of which one ends are fixed on a substrate and which are made of elastomer so that the outer frame is displaceable in first and second directions which are orthogonal to the optical axis direction and are orthogonal to each other, and
a plurality of second driving coils which are opposed to the permanent magnets in the optical axis direction and drive the outer frame in the first and second directions are formed on the substrate.

6. The actuator for camera according to claim 2, wherein
the outer frame is supported by a plurality of second supporting members of which one ends are fixed on a substrate and which are made of elastomer so that the outer frame is displaceable in first and second directions which are orthogonal to the optical axis direction and are orthogonal to each other, and
a plurality of second driving coils which are opposed to the permanent magnets in the optical axis direction and drive the outer frame in the first and second directions are formed on the substrate.

7. The actuator for camera according to claim 3, wherein
the outer frame is supported by a plurality of second supporting members of which one ends are fixed on a substrate and which are made of elastomer so that the outer frame is displaceable in first and second directions which are orthogonal to the optical axis direction and are orthogonal to each other, and
a plurality of second driving coils which are opposed to the permanent magnets in the optical axis direction and drive the outer frame in the first and second directions are formed on the substrate.

8. The actuator for camera according to claim 4, wherein
the outer frame is supported by a plurality of second supporting members of which one ends are fixed on a substrate and which are made of elastomer so that the outer frame is displaceable in first and second directions which are orthogonal to the optical axis direction and are orthogonal to each other, and
a plurality of second driving coils which are opposed to the permanent magnets in the optical axis direction and drive the outer frame in the first and second directions are formed on the substrate.

9. The actuator for camera according to claim 5, wherein the first supporting members and the second supporting members are integrally molded.

10. The actuator for camera according to claim 6, wherein the first supporting members and the second supporting members are integrally molded.

11. The actuator for camera according to claim 7, wherein the first supporting members and the second supporting members are integrally molded.

12. The actuator for camera according to claim 8, wherein the first supporting members and the second supporting members are integrally molded.

13. The actuator for camera according to claim 9, wherein the outer frame and the inner frame are made of resin and the first and second supporting members are formed on the outer frame and the inner frame by secondary molding.

14. The actuator for camera according to claim 10, wherein the outer frame and the inner frame are made of resin and the first and second supporting members are formed on the outer frame and the inner frame by secondary molding.

15. The actuator for camera according to claim 11, wherein the outer frame and the inner frame are made of resin and the first and second supporting members are formed on the outer frame and the inner frame by secondary molding.

16. The actuator for camera according to claim 12, wherein the outer frame and the inner frame are made of resin and the first and second supporting members are formed on the outer frame and the inner frame by secondary molding.

17. The actuator for camera according to claim 9, wherein the first and second supporting members have conductivity.

18. The actuator for camera according to claim 10, wherein the first and second supporting members have conductivity.

19. The actuator for camera according to claim 11, wherein the first and second supporting members have conductivity.

20. The actuator for camera according to claim 12, wherein the first and second supporting members have conductivity.

21. The actuator for camera according to claim 13, wherein the first and second supporting members have conductivity.

22. The actuator for camera according to claim 14, wherein the first and second supporting members have conductivity.

23. The actuator for camera according to claim 15, wherein the first and second supporting members have conductivity.

24. The actuator for camera according to claim 16, wherein the first and second supporting members have conductivity.
